(19) United States
(12) Patent Application Publication
(10) Pub. No.: US 2010/0142788 A1
(43) Pub. Date: Jun. 10, 2010

(54) MEDICAL IMAGE PROCESSING APPARATUS AND METHOD

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT, INC., Tokyo (JP)

(21) Appl. No.: 12/631,231

(22) Filed: Dec. 4, 2009

(30) Foreign Application Priority Data
Dec. 5, 2008 (JP) P2008-311192

(51) Int. Cl. G06K 9/00

(52) U.S. Cl. 382/131

(57) ABSTRACT

There is provided a medical image processing apparatus for visualizing a tubular tissue contained in volume data. The apparatus includes: a central path determination section that determines a central path of the tubular tissue; a diameter determination section that determines a diameter of the tubular tissue at a certain point on the central path; a spacing determination section that determines at least two or more different projection spacings for projecting virtual rays along the central path, depending on the diameter of the tubular tissue; a cylindrical projection section that projects the virtual rays along the central path with the projection spacing that depends on the diameter of the tubular tissue; and an image generation section that generates a cylindrical projection image of the tubular tissue, based on information provided by projecting the virtual rays and the volume data.

This application is based on and claims priority from Japanese Patent Application No. 2008-311192, filed on Dec. 5, 2008, the entire contents of which are hereby incorporated by reference.

### BACKGROUND OF THE INVENTION

1. Technical Field

The present disclosure relates to a medical image processing apparatus and method. More particularly, the present disclosure relates to a medical image processing apparatus and method for generating a cylindrical projection image of a tubular tissue with no distortion in the aspect ratio.

2. Related Art

In recent years, attention has been focused on a technology of visualizing the inside of a three-dimensional object according to the image processing technology using a computer. Particularly, medical diagnosis using an image of Computed Tomography (CT) or a Magnetic Resonance Imaging (MRI), which makes it possible to visualize the inside of a living body, has been widely conducted in a medical field to find a lesion at an early stage.

Also, volume rendering has been used for obtaining a three-dimensional image of the inside of an object. In the volume rendering (typically raycast method), a virtual ray is projected onto three-dimensional voxels (minute volume elements) constituting volume data. Thus, an image is projected onto a projection plane and volume data are visualized. Particularly, in the ray casting method, sampling is performed at given intervals along the path of the virtual ray, and the voxel value is acquired from the voxel at each sampling point. Then, reflected light at each sampling point is stored, and thus volume data are visualized. Some other volume rendering method, for example, a Maximum Intensity Projection (MIP) method, in which the maximum value of the voxels on the virtual ray is acquired to visualize voxel data, is used.

The voxel is a unit of a three-dimensional region of an object and the voxel value is unique and representing the characteristics of the voxel, such as the density value of the voxel. The voxel value is a scalar value in the CT apparatus, but may be a vector value containing color information. The whole object is represented by the voxel data which are a three-dimensional array of the voxel values. Usually, two-dimensional tomographic image data are acquired by the computed tomography (CT) apparatus. Then, the respective two-dimensional tomographic image data are stacked in a direction perpendicular to the tomographic plane and necessary interpolation is performed. Thus, voxel data of the three-dimensional array are obtained.

In the ray casting method, a virtual ray is applied from a virtual eye point to an object, and a virtual reflected light reflected by the object is produced in response to the opacity value artificially set for the voxel value. To capture a virtual surface, the gradient of voxel data, i.e., a normal vector is found and a shading coefficient is calculated from the cosine of the angle between the virtual ray and the normal vector. The virtual reflected light is calculated by multiplying the strength of the virtual ray applied to the voxel by the opacity value of the voxel and the shading coefficient. Also, artificially-setup color may be added to the voxel value.

In visualizing the tubular tissue in the inside of a living body by volume rendering, a parallel projection method or a perspective projection method can be employed. In the parallel projection method, a virtual ray is projected in parallel from a virtual eye point, and thus it is appropriate for observing the tubular tissue from the outside. On the other hand, in the perspective projection method, a virtual ray is projected radially from a virtual eye point, and thus it is appropriate for observing the tubular tissue from the inside thereof. Thus, in the perspective projection method, the endoscopy of the tubular tissue can be simulated. However, to observe the tubular tissue while moving in the inside of the tubular tissue, it is hard to precisely grasp the position and the size of a polyp in the tube wall.

Meanwhile, in visualizing the tubular tissue in the inside of a living body by the volume rendering, a virtual ray is projected radially from the central path of the tubular tissue, whereby an image can be created as if an cylindrical projection image of the tubular tissue were created using a cylindrical coordinate system. This is so-called a cylindrical projection image. In this cylindrical projection image, the position of a polyp in the tube wall, and the size and the shape of the polyp can be observed with one image. In addition, a curved cylindrical projection image provided by performing cylindrical projection onto a winding tubular tissue with the curved central path is also a kind of cylindrical projection image.

FIG. 8A shows a state that a virtual ray 92 is projected radially onto a tube wall 83 of a tubular tissue from a central path 84. FIG. 8B schematically shows a projection plane 85 defined by the central path 84. FIG. 8C shows an unfolded view of the projection plane 85 shown in FIG. 8B.

As shown in FIG. 8A, a virtual eye point 91 is set on the central path 84 of the tubular tissue and the virtual ray 92 is projected radially in a direction perpendicular to the central path 84 from the virtual eye point 91. At this time, as shown in FIG. 8B, the projection plane 85 is represented by cylindrical coordinates C (h, α) using a distance h along the central path 84 and an angle a around the central path 84. If the cylindrical coordinates C (h, α) are converted into two-dimensional coordinates I (u, v), an unfolded view provided by cutting the projection plane 85 along the dotted line in the figure is obtained as shown in FIG. 8C. The unfolded view shown in FIG. 8C corresponds to a cylindrical projection image of the projection plane 85 and the tube wall 83 of the tubular tissue can be observed on the unfolded view.

As described above, the projection plane 85 defined by the central path 84 is represented by the cylindrical coordinates C (h, α) and cylindrical projection is performed from the central path 84. Thus, a 360-degree panoramic image of the tube wall 83 of the tubular tissue can be created.

By the way, when creating a cylindrical projection image of the tube wall 83 of the tubular tissue, spacing of the virtual rays 92 along the central path 84 is constant. Meanwhile, spacing in the circumferential direction perpendicular to the virtual ray 92 projected from a certain position on the central path 84 is constant with respect to the projection plane 85, but is not constant with respect to the tube wall 83 of the tubular tissue. This is because the diameter of the tubular tissue is not always constant.

Accordingly, the projection spacing of the virtual ray 92 in the circumferential direction perpendicular to the central path 84 and the projection spacing of the virtual ray 92 in the direction along the central path 84 will be now discussed with reference to FIG. 9. FIG. 9 is a drawing to show the projection spacing of the virtual ray 92 on the tube wall 83 (rather than on the projection plane) of a tubular tissue 80 represented by cylindrical coordinates.

As shown in FIG. 9, the tubular tissue 80 has a large diameter part 81 and a small diameter part 82. Projection spacing A of the virtual ray 92 along the direction of the central path 84 in the large diameter part 81 is the same as that in the small diameter part 82. Meanwhile, the projection spacing of the virtual ray 92 along the circumferential direction of the tubular tissue 80 in the large diameter part 81 is spacing B1 and that in the small diameter part 82 is spacing B2, which is different from spacing B1.

As described above, with change in the projection spacing of the virtual rays, for example, if an object exists on a tube wall of a tubular tissue, the shape of the object largely changes on the cylindrical projection image of the tube wall of the tubular tissue depending on where the object exists.

The cylindrical projection image of an object existing on the tube wall 83 of the tubular tissue 80 shown in FIG. 9 will be now described with reference to FIGS. 10A and 10B. FIG. 10A is a drawing to show the appearance of the tube wall 83 of the tubular tissue 80 and FIG. 10B is a drawing to show the cylindrical projection image of the tube wall 83 of the tubular tissue 80 shown in FIG. 10A.

As shown in FIG. 10A, a plurality of objects 70A, 70B, and 70C having the same shape exist on the tube wall 83 of the tubular tissue 80. Object 70A exists on the large diameter part 81 of the tubular tissue 80. Object 70C exists on the small diameter part 82 of the tubular tissue 80. Object 70B exists between the large diameter part 81 and the small diameter part 82 of the tubular tissue 80.

In FIG. 10A, the objects of 70A, 70B, and 70C are of the same shape. However, the objects of 70A, 70B, and 70C are visualized in different shapes on the cylindrical projection image of the tube wall 83 of the tubular tissue 80 shown in FIG. 10B.

Namely, on the cylindrical projection image of the tube wall 83 of the tubular tissue 80 shown in FIG. 10B, as the diameter of the tubular tissue 80 lessens, the width of each of the objects of 70A, 70B, and 70C in the circumferential direction thereof (in the figure, open arrow) widens. Meanwhile, if the diameter of the tubular tissue 80 changes, the width of each object of 70A, 70B, and 70C in the center axis 84 direction thereof (in the figure, solid arrow) does not change at all. Thus, the aspect ratio of each object of 70A, 70B, and 70C is distorted on the cylindrical projection image of the tube wall 83 of the tubular tissue 80 shown in FIG. 10B. (see, for example, U.S. Application Pub. No. 2007/120845, U.S. Application Pub. No. 2008/055308 and A. Vilanova Bartroli, R. Wegenkittl, A. Konig, E. Groller, “Virtual Colon Unfolding,” IEEE Visualization, USA, 2001, p 411-420)

As described above, if the tubular tissue having different diameters is simply displayed on a cylindrical projection image, the aspect ratio of an object is distorted depending on the position of the object existing on the tubular tissue. Thus, for example, if a polyp (i.e., object) exists on the tube wall of a colon (i.e., on a tubular tissue of a living body), the aspect ratio of the polyp is distorted on the cylindrical projection image. Consequently, for example, it becomes hard to distinguish between the polyp and the tissue of the wall of the colon, which leads to obstruction of image diagnosis.

### SUMMARY OF THE INVENTION

Exemplary embodiments of the present invention are in relation to the above disadvantages and other disadvantages not described above. However, the present invention is not required to overcome the disadvantages described above, and thus, an exemplary embodiment of the present invention may not overcome any of the problems described above.

It is an illustrative aspect of the present invention to provide a medical image processing apparatus and a method capable of generating a cylindrical projection image of a tubular tissue with no distortion in the aspect ratio even if the diameter of the tubular tissue is changed.

According to one or more illustrative aspects of the present invention, there is provided a medical image processing apparatus for visualizing a tubular tissue contained in volume data. The apparatus comprises: a central path determination section that determines a central path of the tubular tissue; a diameter determination section that determines a diameter of the tubular tissue at a certain point on the central path; a spacing determination section that determines at least two or more different projection spacings for projecting virtual rays along the central path, depending on the diameter of the tubular tissue; a cylindrical projection section that projects the virtual rays along the central path with the projection spacing that depends on the diameter of the tubular tissue; and an image generation section that generates a cylindrical projection image of the tubular tissue, based on information provided by projecting the virtual rays and the volume data.

According to one or more illustrative aspects of the present invention, there is provided a medical image processing method for visualizing a tubular tissue contained in volume data. The method comprises: (a) determining a central path of the tubular tissue based on volume data of voxel space containing the tubular tissue; (b) determining a diameter of the tubular tissue at a certain point on the central path; (c) determining at least two or more different projection spacings for projecting virtual rays along the central path, depending on the diameter of the tubular tissue; (d) projecting the virtual rays along the central path with the projection spacing that depends on the diameter of the tubular tissue; and (e) generating a cylindrical projection image of the tubular tissue, based on information provided by projecting the virtual rays and the volume data.

Other aspects of the invention will be apparent from the following description, the drawings and the claims.

### BRIEF DESCRIPTION OF THE DRAWINGS

In the accompanying drawings:

FIG. 1 is a drawing to show an example of using a medical image processing apparatus 100 according to an exemplary embodiment of the present invention in combination with a computed tomography apparatus 400;

FIG. 2 is a block diagram to show the internal configuration of the medical image processing apparatus 100 according to the exemplary embodiment;

FIG. 3 is a flowchart to show the operation of the medical image processing apparatus 100 according to the exemplary embodiment;

FIG. 4A is a sectional view taken along the central path of a tubular tissue; FIG. 4B is a drawing to show a cylindrical projection image of the tubular tissue;

FIGS. 5A to 5C are drawings to describe the distance between two points and the angle between two line segments on each cylindrical projection image unfolded in different positions;

FIGS. 6A and 6B are drawings to show appearances and cylindrical projection images of a tubular tissue at different attention points;

FIG. 7 is a drawing to show an appearance and a cylindrical projection image of a tubular tissue;

FIG. 8A is a drawing to show a virtual ray 92 projected radially from a central path 84 set in a tubular tissue;

FIG. 8B schematically shows a projection plane 85 defined by the central path 84;

FIG. 8C shows an unfolded view of the projection plane 85 shown in FIG. 8B;

FIG. 9 is a drawing to show the projection spacing of virtual rays on the tube wall 83 of a tubular tissue 80; and

FIGS. 10A and 10B are drawings to show an appearance and a cylindrical projection image of the tubular tissue 80.

### DETAILED DESCRIPTION OF EXEMPLARY EMBODIMENTS

Exemplary embodiments of the present invention will be now described with reference to the drawings.

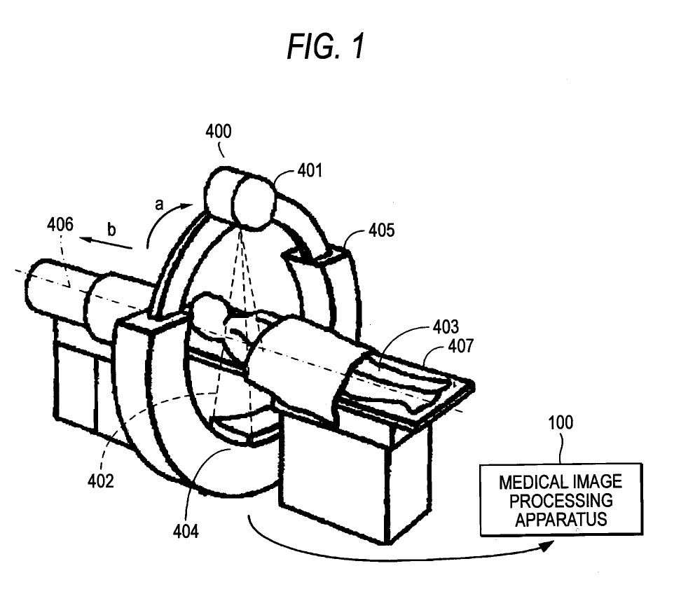

FIG. 1 shows an example of using a medical image processing apparatus 100 according to an exemplary embodiment of the present invention in combination with a computed tomography (CT) apparatus 400. As shown in FIG. 1, the CT apparatus 400 is used to visualize the tissue of a specimen. The CT apparatus 400 includes an X-ray source 401 that is a radiation source of an X-ray beam bundle 402, an X-ray detector 404, a ring-like gantry 405, and a table 407 through which an X ray passes.

The X-ray source 401 radiates the X-ray beam bundle 402, which is shaped like a pyramid as indicated by the chain line in the figure. The X-ray detector 404 detects the X-ray beam bundle 402 passing through a patient 403 on the table 407. Further, the X-ray detector 404 outputs a signal of the detected X-ray beam bundle 402 to an medical image processing apparatus 100. The X-ray source 401 and the X-ray detector 404 are provided to face each other on the ring-like gantry 405.

The X-ray source 401 and the X-ray detector 404 are configured to rotate around a system axis 406 and move along the system axis 406 (i.e., movable relative to the patient 403). Thus, the X-ray beam bundle 402 is projected onto the patient 403 at various projection angles and various positions with respect to the system axis 406.

The ring-like gantry 405 is supported by a retainer (not shown) and rotatable (see arrow “a”) relative to the system axis 406 passing through the center point of the gantry 405.

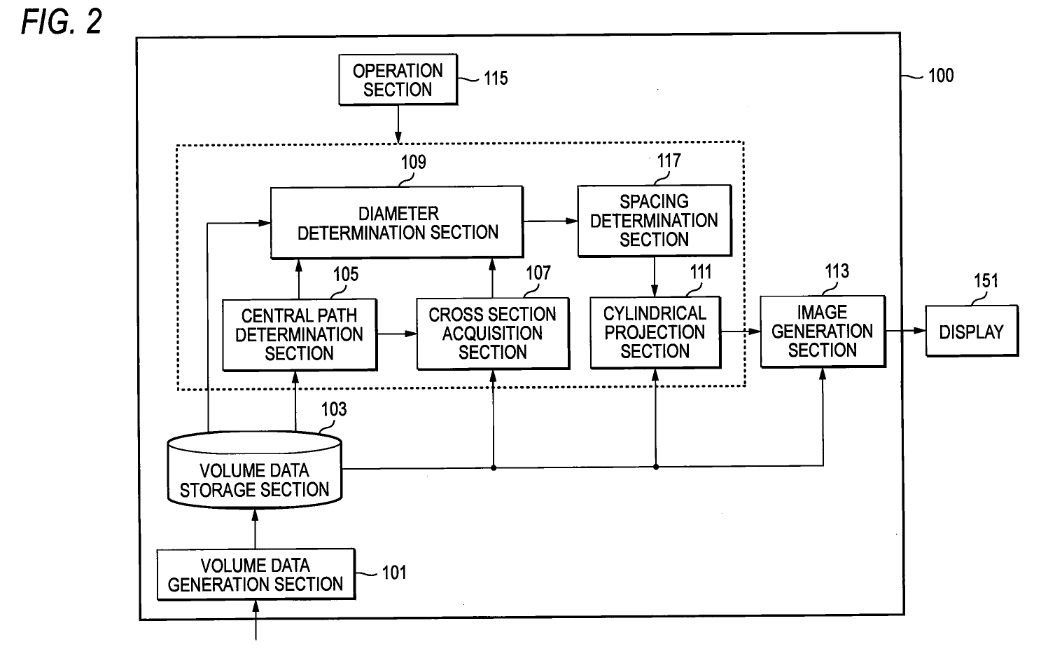

FIG. 2 is a block diagram to show the internal configuration of the medical image processing apparatus 100 according to the exemplary embodiment of the invention. As shown in FIG. 2, the medical image processing apparatus 100 includes: a volume data generation section 101; a volume data storage section 103; a central path determination section 105; a cross section acquisition section 107; a diameter determination section 109; a cylindrical projection section 111; an image generation section 113; an operation section 115; and a spacing determination section 117.

The volume data generation section 101 receives a large number of successive tomographic signals in the diagnosis range of the patient 403 from the CT apparatus 400. The volume data generation section 101 generates volume data of voxel space containing a tubular tissue, based on the received signals. The volume data storage section 103 stores the volume data generated by the volume data generation section 101.

The central path determination section 105 determines the area of the tubular tissue existing in the voxel space based on the volume data obtained from the volume data storage section 103 and then determines the central path of the tubular tissue. The central path is a straight line or a curve.

The cross section acquisition section 107 reads the volume data of the cross section of the tubular tissue at a certain point on the central path determined by the central path determination section 105 from the volume data storage section 103. Then, the cross section acquisition section 107 generates a function representing the cross-sectional area of the tubular tissue. The cross-sectional area of the tubular tissue means the area which is surrounded by the tubular tissue.

The diameter determination section 109 determines the diameter of the tubular tissue at a certain point on the central path, based on the function generated by the cross section acquisition section 107. When the diameter determination section 109 determines the diameter of the tubular tissue, the diameter determination section 109 calculates an area S of the cross-sectional area of the tubular tissue at the point on the central path of the tubular tissue from the function generated by the cross section acquisition section 107, and then determines the square root of the area S as a diameter r of the tubular tissue at the point (r=√S).

The diameter determination section 109 may determine the maximum length of the lengths until the virtual rays projected on the cross-sectional area from the points on the central path are attenuated by the tubular tissue as the diameter r of the tubular tissue at each point. The diameter determination section 109 may determine the diameter of a circle inscribing or a circle circumscribing the cross-sectional area of the tubular tissue at each point on the central path as the diameter r of the tubular tissue at the point. The diameter determination section 109 may determine the diameter r of the tubular tissue without calculating a function representing the cross-sectional area of the tubular tissue in the cross section acquisition section 107. In this case, the diameter determination section 109 determines the area of the tubular tissue existing in the voxel space from the volume data stored in the volume data storage section 103, and then determines the diameter of a sphere inscribing the cross section of the area of the tubular tissue at each point on the central path determined by the central path determination section 105 as the diameter r of the tubular tissue at the point. The diameter determination section 109 may make adjustment such as determining the diameter r of the tubular tissue throughout the tubular tissue using the above-described determination methods of the diameter r of the tubular tissue in combination.

The spacing determination section 117 determines spacing on the central path for projecting the virtual rays in accordance with the diameter r of the tubular tissue at each point determined by the diameter determination section 109. The spacing on the central path for projecting the virtual rays is α×r (where α is a constant) ideally, but it is possible to make a correction in view of the characteristic that the diameter of the tubular tissue cannot strictly be defined. The diameters at peripheral points (for example, weighted average) are used in addition to the diameter at each point on the central path, whereby the effect of noise mixed in calculating the diameter r of the tubular tissue can be decreased.

The cylindrical projection section 111 projects the virtual rays along the central path of the tubular tissue with the spacing α×r determined by the spacing determination section 117 according to the cylindrical projection method. The virtual ray projection method of the cylindrical projection section 111 may be “curved cylindrical projection method” or “correction cylindrical projection method” described in U.S. Application Pub. No. 2007/120845 or “umbrella-type projection method” described in U.S. Application Pub. No. 2006/221074. That is, the virtual ray projection method may be a projection method of projecting each virtual ray from the central path used as the reference.

The image generation section 113 generates a cylindrical projection image of the tubular tissue by performing rendering based on the information provided by projecting virtual rays by the cylindrical projection section 111 and the volume data read from the volume data storage section 103. The image generation section 113 displays the generated cylindrical projection image on a display 151.

The image generation section 113 may display the numerical value of the diameter r of the tubular tissue at the attention point on the central path together with the cylindrical projection image. The image generation section 113 may display a ruler for measuring the size of the cylindrical projection image together with the cylindrical projection image. The user of the medical image processing apparatus 100 can visually grasp the size of the lesion or the tube wall of the tubular tissue while seeing the numerical value of the diameter r and the ruler.

The operation section 115 accepts operation of the user of the medical image processing apparatus 100 to set or change the attention point on the central path of the tubular tissue. The operation section 115 may be a keyboard or a mouse, for example.

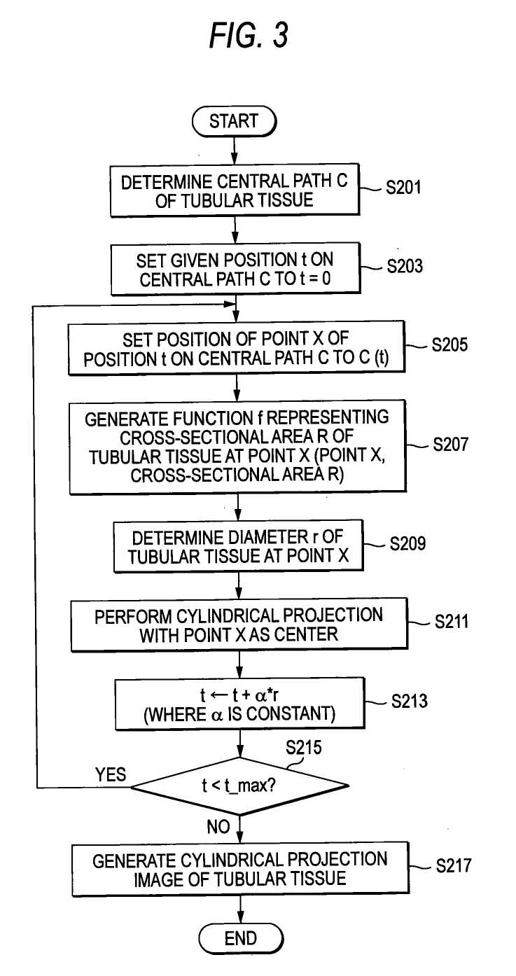

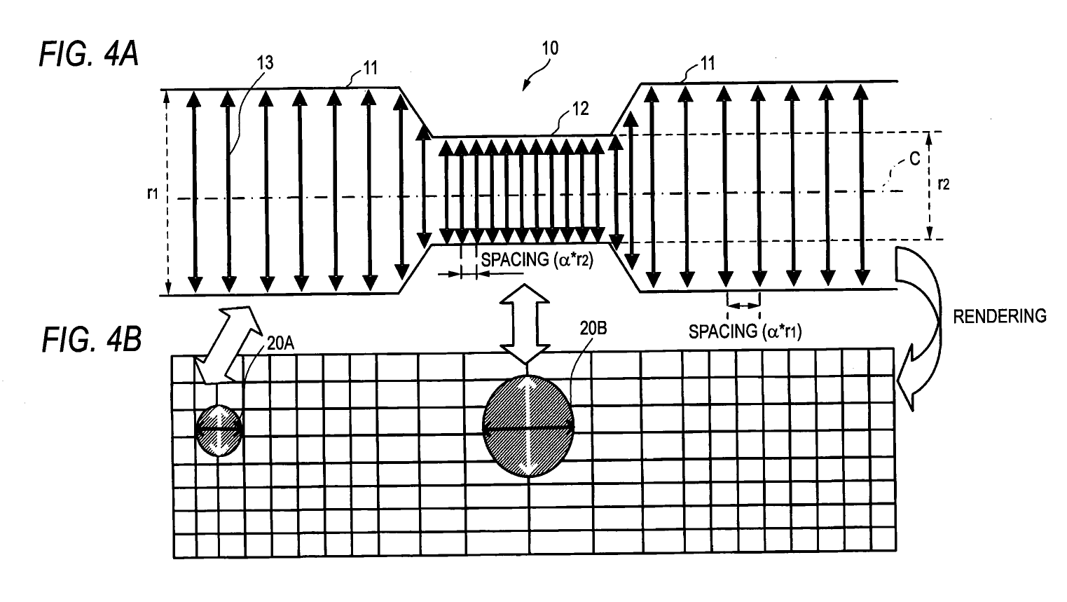

The operation of the medical image processing apparatus 100 according to the exemplary embodiment will be now described with reference to FIGS. 3 to 4B. FIG. 3 is a flowchart to describe the operation of the medical image processing apparatus 100 according to the exemplary embodiment of the present invention. FIG. 4A is a sectional view taken along the central path of the tubular tissue. FIG. 4B is a drawing to show a cylindrical projection image of the tubular tissue.

First of all, the central path determination section 105 determines a central path C of the tubular tissue based on the volume data obtained from the volume data storage section 103 (step S201). Next, the central path determination section 105 initializes a given position t on the central path C to t=0 (step S203).

Next, the cross section acquisition section 107 sets the position of a point X of the position t on the central path C to C(t) (step S205). Next, the cross section acquisition section 107 reads the volume data of the cross section of the tubular tissue at the point X from the volume data storage section 103 and then generates a function f that represents a cross-sectional area R of the tubular tissue (point X, cross-sectional area R) (step S207).

Next, the diameter determination section 109 determines the diameter r of the tubular tissue at the point X, based on the function f generated at step 5207 (step S209). Next, the cylindrical projection section 111 projects each virtual ray with the point X as the center according to the cylindrical projection method (step S211). That is, the cylindrical projection section 111 projects the virtual ray radially in the circumferential direction perpendicular to the central path C from the point X.

Next, the cylindrical projection section 111 changes the value “t” of the position C(t) of the point X to the value “t+α×r (where a is a constant)” (step S213). According to the step, the position t of projecting the virtual ray by the cylindrical projection section 111 moves by “α×r” along the central path C. That is, the move spacing of the virtual ray projection position t changes in response to the value of the diameter r of the tubular tissue, as shown in FIG. 4A.

Next, the cylindrical projection section 111 makes a comparison between the value of the position t on the central path C and maximum value t_max (step S215). If the value of the position t on the central path C is less than the maximum value t_max (YES at step S215), the process returns to step S205 and steps 5205 to S215 are repeatedly performed. Therefore, while the point X exists in a given range along the central path of the tubular tissue, the cylindrical projection section 111 performs cylindrical projection of virtual ray at step 5211. On the other hand, if the value of the position t on the central path C is equal to or greater than the maximum value t_max (NO at step S215), the process goes to step 5217.

At step 5217, the image generation section 113 generates a cylindrical projection image of the tubular tissue, based on the volume data read from the volume data storage section 103 and information provided by projecting virtual rays by the cylindrical projection section 111.

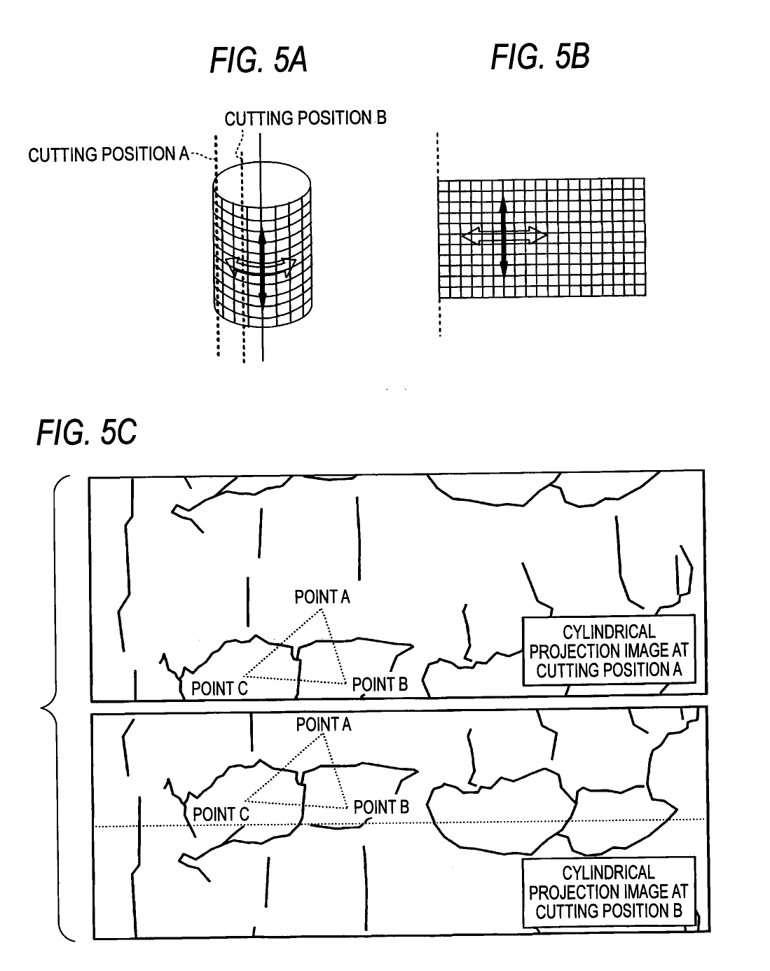

Projection of virtual ray and the cylindrical projection image of a tubular tissue will be now described with reference to FIGS. 4A to 5C. In the description, a tubular tissue 10 having different diameters will be now described with reference to FIG. 4A. The tubular tissue 10 has a large diameter part 11 having a radius r₁ and a small diameter part 12 having a radius r₂ (r₂<r₁). Although not shown in FIG. 4A, it is assumed that lesions 20A and 20B identical in shape and size exist on the tube walls of the large diameter part 11 and the small diameter part 12, respectively.

As shown in FIG. 4A, the cylindrical projection section 111 radially projects virtual ray 13 in the circumferential direction perpendicular to the central path C from a point on the central path C of the tubular tissue 10. In the exemplary embodiment, as described above, spacing on the central path C for projecting the virtual ray 13 is (α×r₁) in the large diameter part 11 and (α×r₂) in the small diameter part 12.

When the virtual ray 13 is projected with the spacing, the lesions 20A and 20B are displayed in the cylindrical projection image of the tubular tissue 10 such that they have the same aspect ratio independent of the diameters of the tubular tissue where the lesions exist, as shown in FIG. 4B. That is, the aspect ratio of each of the lesions 20A and 20B on the cylindrical projection image generated by the medical image processing apparatus 100 according to the exemplary embodiment is not distorted. Therefore, the user of the medical image processing apparatus 100 can precisely grasp the shapes of the lesions.

To generate a cylindrical projection image of a tubular tissue, the medical image processing apparatus 100 of the exemplary embodiment unfolds a cylindrical projection plane onto two-dimensional coordinates. The distance between two points and the angle between two line segments on the cylindrical projection image do not change depending on the unfolded position of the tubular tissue (virtual cylinder cut area) as shown in FIG. 5C.

FIGS. 5A to 5C are drawings to describe the distance between two points and the angle between two line segments on cylindrical projection images each of which is unfolded at a different position. FIG. 5A is a drawing to show the appearance of a cylindrical projection plane. FIG. 5B is an unfolded view, which is unfolded in two-dimensional coordinates, of the cylindrical projection plane shown in FIG. 5A. FIG. 5C is a drawing to show cylindrical projection images in which the tube wall of the tubular tissue shown in FIG. 5A is unfolded at different positions. The medical image processing apparatus 100 of the exemplary embodiment unfolds a cylindrical projection plane as shown in FIG. 5A onto two-dimensional coordinates shown in FIG. 5B. If the diameter of the tubular tissue changes, the distance between two points and the angle between two line segments on the cylindrical projection image do not change depending on unfolded position.

Thus, as shown in FIG. 5C, if a comparison is made between the cylindrical projection image unfolded at a cutting position A and the cylindrical projection image unfolded at a cutting position B, the distance between points A and B, the distance between points B and C, and the distance between points C and A on one cylindrical projection image are the same as those on the other cylindrical projection image. Likewise, if a comparison is made between the cylindrical projection image unfolded at an the cutting position A and the cylindrical projection image unfolded at the cutting position B, the angle between line segments AB and BC, the angle between line segments BC and CA, and the angle between line segments CA and AB on one cylindrical projection image are the same as those on the other cylindrical projection image.

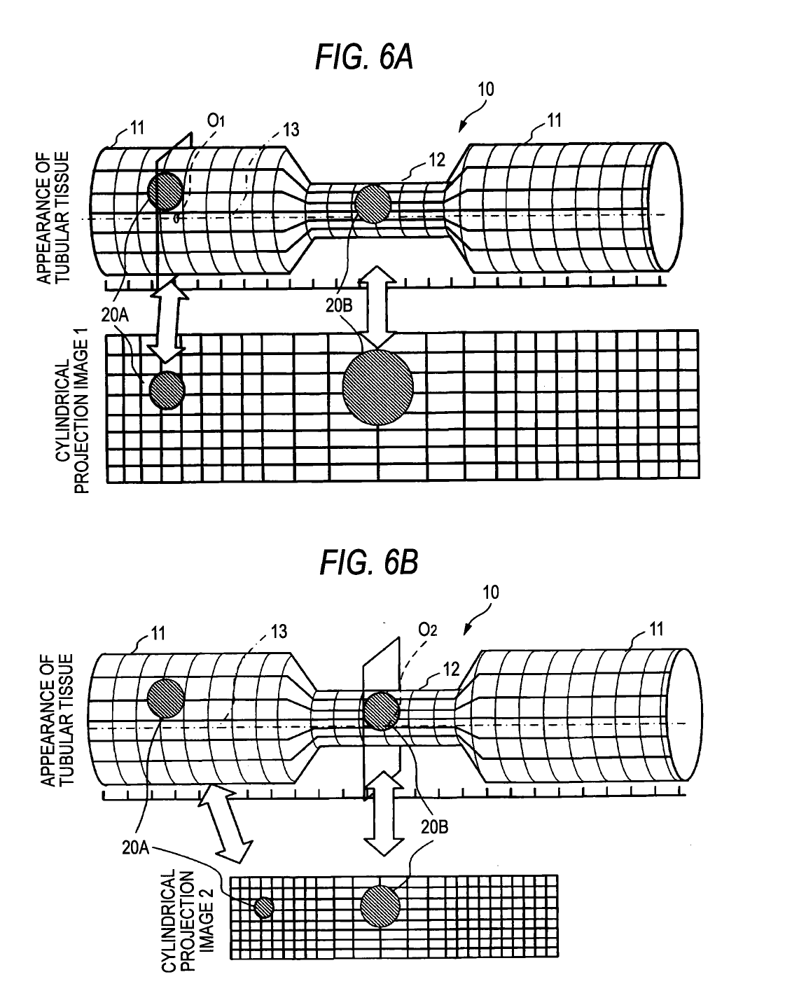

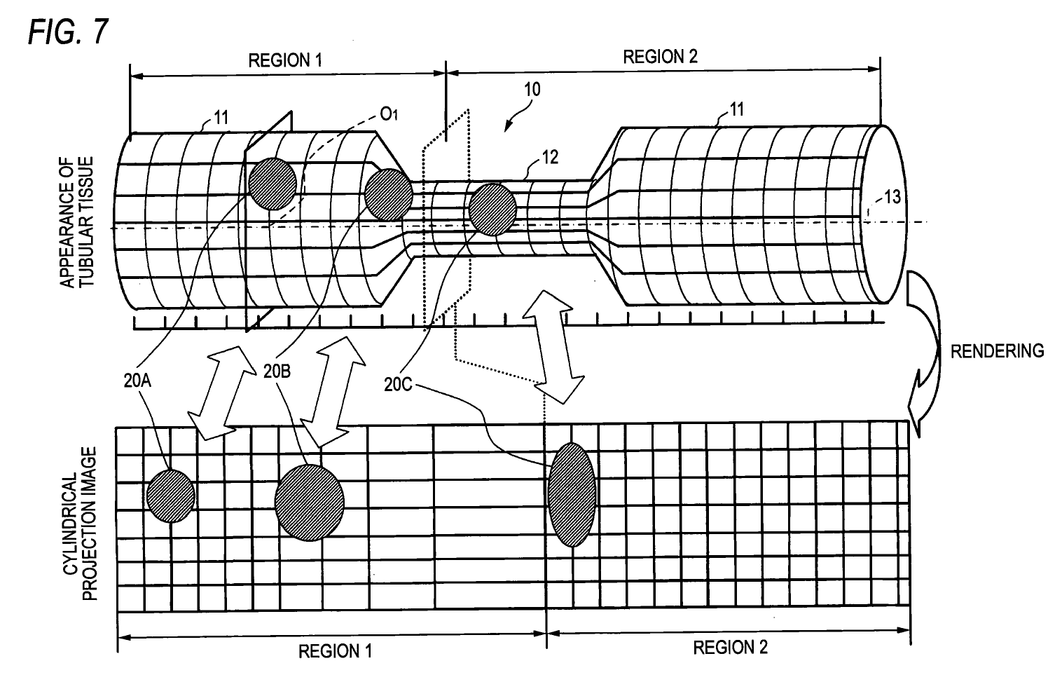

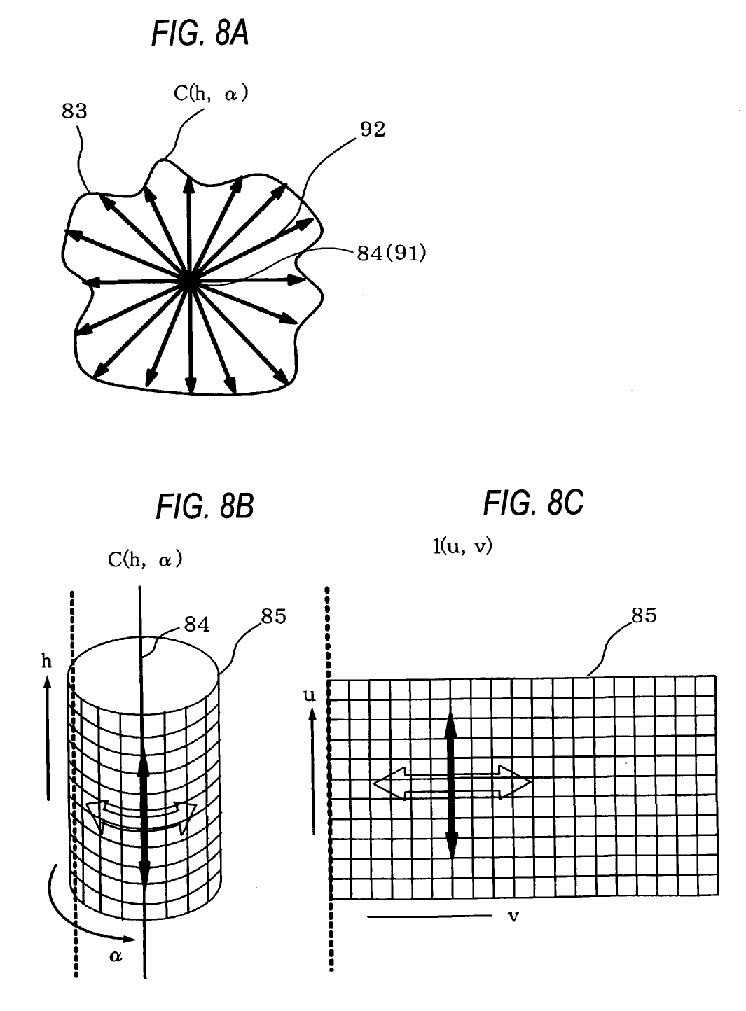

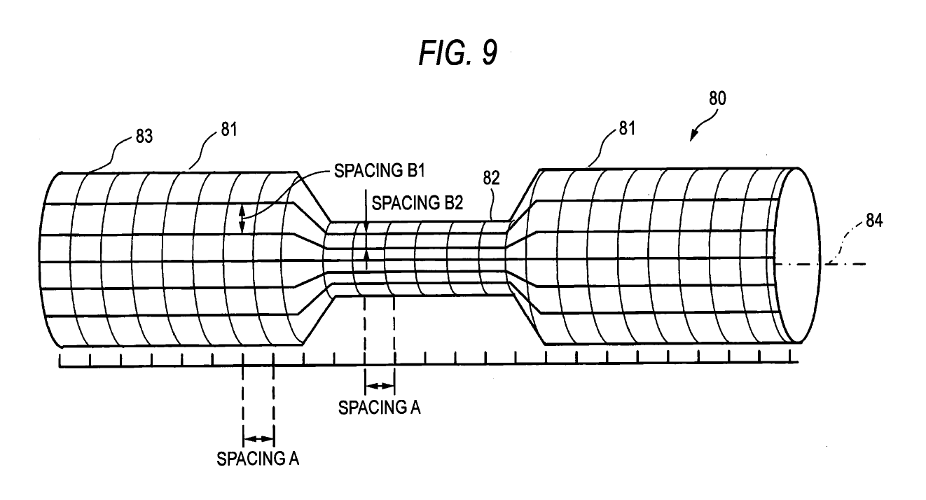

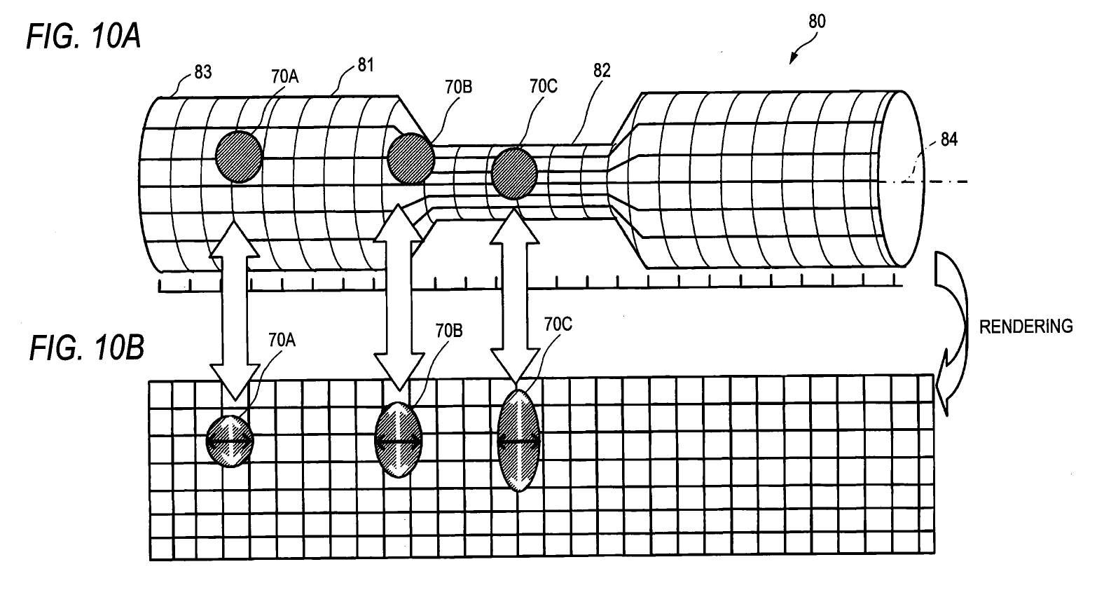

Next, a display method of a cylindrical projection image of a tubular tissue generated by the medical image processing apparatus 100 will be now described with reference to FIGS. 6A to 7. For the description, FIGS. 6A to 7 show the appearances of a tubular tissue corresponding to cylindrical projection images. However, only the cylindrical projection image may be displayed on the display 151 or both the appearance of the tubular tissue and the cylindrical projection image may be displayed on the display 151. The cylindrical projection image of the tubular tissue displayed on the display 151 is changed in response to the operation of the user using the operation section 115.

### First Display Example

A first display example of a cylindrical projection image of a tube wall of a tubular tissue will be now described with reference to FIGS. 6A and 6B. The tubular tissue shown in FIGS. 6A and 6B is the same as the tubular tissue 10 shown in FIG. 4A. FIG. 6A shows the appearance and the cylindrical projection image of the tubular tissue 10 when an attention point is set on the central path of the large diameter part 11 of the tubular tissue 10. FIG. 6B shows the appearance and the cylindrical projection image of the tubular tissue 10 when an attention point is set on the central path of the small diameter part 12 of the tubular tissue 10.

As shown in FIGS. 6A and 6B, the image generation section 113 changes the size of a cylindrical projection image in response to the diameter of the tubular tissue 10 at the attention point set on the central path of the tubular tissue 10. An attention point O₁ shown in FIG. 6A is positioned in the large diameter part 11 and an attention point O₂ shown in FIG. 6B is positioned in the small diameter part 12 and thus a cylindrical projection image 1 shown in FIG. 6A is larger than a cylindrical projection image 2 shown in FIG. 6B. The size of the cylindrical projection image is proportional to the diameter of the tubular tissue at the attention point. Since the image generation section 113 changes the size of the cylindrical projection image without changing the aspect ratio of the cylindrical projection image, the aspect ratios of lesions 20A and 20B on the cylindrical projection image do not change.

If the size of the cylindrical projection image is thus changed in response to the diameter of the tubular tissue, the user can visually grasp the diameter of the tubular tissue and the size of the lesion. For example, FIGS. 6A and 6B show the lesions 20A and 20B of the same size in the appearance of the tubular tissue, and the lesion 20A shown in the cylindrical projection image 1 and the lesion 20B shown in the cylindrical projection image 2 are of the same size, so that the user can precisely grasp the size of each lesion.

If two or more attention points are set, the image generation section 113 may display a plurality of cylindrical projection images with the sizes which correspond to the respective diameters of the tubular tissue at the attention points.

### Second Display Example

A second display example of a cylindrical projection image of a tube wall of a tubular tissue will be now described with reference to FIG. 7. The tubular tissue shown in FIG. 7 is also the same as the tubular tissue 10 shown in FIG. 4A. FIG. 7 is a drawing to show the appearance and the cylindrical projection image of the tubular tissue 10.

As shown in FIG. 7, the cylindrical projection image at an attention point O₁ is divided into two regions 1 and 2. The cylindrical projection image in the region 1 is a cylindrical projection image generated according to the method described above. On the other hand, the cylindrical projection image in the region 2 is a cylindrical projection image generated according to another method. Thus, the image generation section 113 may continuously display different types of cylindrical projection images generated according to different methods for each region.

When the image processing load on the image generation section 113 varies from one method to another, if the method is changed in response to the region of the cylindrical projection image, the load on the image generation section 113 can be reduced. Further, the screen area can be saved.

As described above, in the medical image processing apparatus 100 according to the exemplary embodiment, the spacing for projecting virtual rays along the central path of a tubular tissue varies depending on the diameter of the tubular tissue. Thus, if the tubular tissue has different diameters, a cylindrical projection image of the tubular tissue can be generated with no distortion in the aspect ratio. Consequently, the user of the medical image processing apparatus 100 can precisely grasp the shape of a lesion existing in the tubular tissue.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. A medical image processing apparatus for visualizing a tubular tissue contained in volume data, the apparatus comprising:
a central path determination section that determines a central path of the tubular tissue;
a diameter determination section that determines a diameter of the tubular tissue at a certain point on the central path;
a spacing determination section that determines at least two or more different projection spacings for projecting virtual rays along the central path, depending on the diameter of the tubular tissue;
a cylindrical projection section that projects the virtual rays along the central path with the projection spacing that depends on the diameter of the tubular tissue; and
an image generation section that generates a cylindrical projection image of the tubular tissue, based on information provided by projecting the virtual rays and the volume data.

2. The medical image processing apparatus as claimed in claim 1,
wherein the image generation section changes the display size of the cylindrical projection image, depending on the projection spacing at an attention point on the central path.

3. A medical image processing method for visualizing a tubular tissue contained in volume data, the method comprising:
(a) determining a central path of the tubular tissue based on volume data of voxel space containing the tubular tissue;
(b) determining a diameter of the tubular tissue at a certain point on the central path;
(c) determining at least two or more different projection spacings for projecting virtual rays along the central path, depending on the diameter of the tubular tissue;
(d) projecting the virtual rays along the central path with the projection spacing that depends on the diameter of the tubular tissue; and
(e) generating a cylindrical projection image of the tubular tissue, based on information provided by projecting the virtual rays and the volume data.

4. The method as claimed in claim 3, wherein step (e) comprises: changing the display size of the cylindrical projection image, depending on the projection spacing at an attention point on the central path
